(19) United States
(12) Patent Application Publication
(10) Pub. No.: US 2023/0185344 A1
(43) Pub. Date: Jun. 15, 2023

(54) COMPUTER CASE STRUCTURE SUSPENDED AND FIXED BY STEEL CABLES

(71) Applicant: TAI-SHENG HAN, New Taipei (TW)

(72) Inventor: TAI-SHENG HAN, New Taipei (TW)

(73) Assignee: EVGA CORPORATION, New Taipei (TW)

(21) Appl. No.: 17/547,129

(22) Filed: Dec. 9, 2021

(51) Int. Cl. G06F 1/18

(52) U.S. Cl. CPC G06F 1/181

(57) ABSTRACT

A computer case structure suspended and fixed by steel cables comprises a main frame, the main frame comprises a top frame and a bottom frame connected to each other, the main frame further comprises a first steel cable set and a second steel cable set disposed on the top frame, and a third steel cable set and a fourth steel cable set assembled on the bottom frame; and a motherboard frame, the motherboard frame is formed with a first assembling hole and a second assembling hole, and a third assembling hole and a fourth assembling hole respectively assembled with the first steel cable set and the second steel cable set, and the third steel cable set and the fourth steel cable set, so that the motherboard frame is capable of suspending and fixing inside the main frame, thereby the motherboard frame is provided with effects of shockproof and buffering.

### BACKGROUND OF THE INVENTION

### Field of Invention

The invention relates to a computer case structure, and more particularly to a computer case structure suspended and fixed by steel cables provided with effects of shockproof and buffering and diversion space to improve a heat dissipation effect.

### Related Art

In the era of technological explosion, people rely on a variety of electronic products to make life more convenient and diversified, to improve efficiency and productivity, and to save a large amount of time. Among the electronic products, personal computer has long been one of the indispensable important tools in everyday life, and most of the computer cases of desktop computer is in an upright rectangular shape. The computer case mainly comprises a main frame and a plurality of panels to correspondingly cover the sides of the main frame, and computer accessories such as motherboard, display interface card, audio interface card, hard disk drive, optical disc drive and power supply unit are installed inside the computer case. However, at present, the motherboard is fixedly assembled on the panel with connectors, when the panel is impacted or shaken, the motherboard will vibrate and has no buffering effect, which will affect the operation of the motherboard. Moreover, the diversion space around the motherboard is restricted by the panels, resulting in limited heat dissipation effect due to poor diversion or air circulation.

Therefore, the inventor of the invention and relevant manufacturers engaged in this industry are eager to research and make improvement to solve the above-mentioned problems and drawbacks in the prior art.

### SUMMARY OF THE INVENTION

Therefore, in order to effectively solve the above-mentioned problems, a main object of the invention is to provide a computer case structure suspended and fixed by steel cables provided with effects of shockproof and buffering and diversion space to improve a heat dissipation effect.

In order to achieve the above object, the invention provides a computer case structure suspended and fixed by steel cables comprising a main frame, the main frame comprises a top frame and a bottom frame connected to each other, and the main frame further comprises a first steel cable set and a second steel cable set, and a third steel cable set and a fourth steel cable set, the first steel cable set is disposed on a front side of the top frame, the second steel cable set is disposed on a rear side of the top frame, the third steel cable set is disposed on a front side of the bottom frame, and the fourth steel cable set is disposed on a rear side of the bottom frame; and a motherboard frame, the motherboard frame is formed with a first assembling hole and a second assembling hole, and a third assembling hole and a fourth assembling hole, the first assembling hole is assembled with the first steel cable set, the second assembling hole is assembled with the second steel cable set, the third assembling hole is assembled with the third steel cable set, and the fourth assembling hole is assembled with the fourth steel cable set, so that the motherboard frame is capable of suspending and fixing inside the main frame.

According to one embodiment of the computer case structure suspended and fixed by steel cables of the invention, wherein the main frame further comprises a front side frame and a rear side frame, a top end of the front side frame is assembled with the front side of the top frame, a bottom end of the front side frame is assembled with the front side of the bottom frame, a top end of the rear side frame is assembled with the rear side of the top frame, a bottom end of the rear side frame is assembled with the rear side of the bottom frame, and the main frame is further provided with a switch assembly, the switch assembly is assembled on the bottom frame, and at least one control switch and at least one connection port are disposed on the switch assembly.

According to one embodiment of the computer case structure suspended and fixed by steel cables of the invention, wherein the motherboard frame is further provided with a plurality of fixing parts and at least one extension part thereon, wherein the fixing part is provided for assembling a motherboard on the motherboard frame, and the extension part is provided for assembling and fixing at least one motherboard accessory.

According to one embodiment of the computer case structure suspended and fixed by steel cables of the invention, wherein the first steel cable set and the second steel cable set are respectively provided with two lock heads, at least one cable and at least one assembling joint, the lock heads of the first steel cable set are assembled with the top frame, one end of the cable is assembled with one of the lock heads, another end of the cable is assembled with the other lock head, the cable of the first steel cable set passes through the first assembling hole, the assembling joint of the first steel cable set is sleeved on the cable and fixed on the first assembling hole, the lock heads of the second steel cable set are assembled with the top frame, one end of the cable is assembled with one of the lock heads, another end of the cable is assembled with the other lock head, the cable of the second steel cable set passes through the second assembling hole, and the assembling joint of the second steel cable set is sleeved on the cable and fixed on the second assembling hole.

According to one embodiment of the computer case structure suspended and fixed by steel cables of the invention, wherein the third steel cable set and the fourth steel cable set are respectively provided with the two lock heads, the at least one cable and the at least one assembling joint, the lock heads of the third steel cable set are assembled with the bottom frame, one end of the cable is assembled with one of the lock heads, another end of the cable is assembled with the other lock head, the cable of the third steel cable set passes through the third assembling hole, the assembling joint of the third steel cable set is sleeved on the cable and fixed on the third assembling hole, the lock heads of the fourth steel cable set are assembled with the bottom frame, one end of the cable is assembled with one of the lock heads, another end of the cable is assembled with the other lock head, the cable of the fourth steel cable set passes through the fourth assembling hole, and the assembling joint of the fourth steel cable set is sleeved on the cable and fixed on the fourth assembling hole.

According to one embodiment of the computer case structure suspended and fixed by steel cables of the invention, wherein the lock head further comprises a frame assembling section, a rotating section and a cable assembling section, wherein one end of the rotating section is assembled with the frame assembling section, another end of the rotating section is assembled with the cable assembling section, and the cable assembling section is assembled with the cable, so that the rotating section is capable of driving the cable assembling section to displace to pull or loosen the cable.

According to one embodiment of the computer case structure suspended and fixed by steel cables of the invention, further comprising at least one expansion frame, a side of the expansion frame is provided with a plurality of expansion hooks to be assembled with the cable, and the expansion frame is provided for assembling and fixing at least one computer accessory.

According to one embodiment of the computer case structure suspended and fixed by steel cables of the invention, further comprising at least one carrying bracket, the carrying bracket is provided with at least one partition tray and a plurality of carrying hooks disposed on sides of the carrying bracket, the carrying hooks are assembled with the cables, and the partition tray is provided for assembling and fixing the computer accessory.

According to one embodiment of the computer case structure suspended and fixed by steel cables of the invention, further comprising at least one expansion rack, and the expansion rack is assembled with the expansion frame.

According to one embodiment of the computer case structure suspended and fixed by steel cables of the invention, further comprising a front cover and a rear cover, a top and a bottom of the front cover and the rear cover are respectively provided with at least one top assembling ring and at least one bottom hook, the top assembling ring is assembled with the top frame, and the bottom hook is assembled with the bottom frame, so that the front cover and the rear cover are fixedly disposed on sides of the main frame and cover the motherboard frame, and the front cover is further formed with a through hole communicating with the switch assembly.

### BRIEF DESCRIPTION OF THE DRAWINGS

FIG. 1 is a perspective assembled view of a computer case structure of the invention;

FIG. 2 is a perspective exploded view of the computer case structure of the invention;

FIG. 3 is a partial exploded view of the computer case structure of the invention;

FIG. 4 is a partial perspective view of implementation of the computer case structure of the invention;

FIG. 5 is a perspective view of implementation of the computer case structure assembling with an expansion frame of the invention;

FIG. 6 is a perspective view of implementation of the computer case structure assembling with a carrying bracket of the invention;

FIG. 7 is a perspective view of implementation of the computer case structure assembling with an expansion rack of the invention;

FIG. 8 is a perspective view of implementation of the computer case structure assembling with a front cover and a rear cover of the invention; and

FIG. 9 is a perspective view of expansional assembly of the computer case structure of the invention.

### DETAILED DESCRIPTION OF THE INVENTION

The above object of the invention, as well as its structural and functional features, will be described in accordance with the preferred embodiments of the accompanying drawings.

In the following, for the formation and technical content related to a computer case structure in the invention, various applicable examples are exemplified and explained in detail with reference to the accompanying drawings; however, the invention is of course not limited to the enumerated embodiments, drawings, or

### DETAILED DESCRIPTIONS

Furthermore, those who are familiar with this technology should also understand that the enumerated embodiments and accompanying drawings are only for reference and explanation, and are not used to limit the invention; other modifications or alterations that can be easily implemented based on the detailed descriptions of the invention are also deemed to be within the scope without departing from the spirit or intention thereof as defined by the appended claims and their legal equivalents.

And, the directional terms mentioned in the following embodiments, for example: “above”, “below”, “left”, “right”, “front”, “rear”, etc., are only directions referring in the accompanying drawings. Therefore, the directional terms are used to illustrate rather than limit the invention. In addition, in the following embodiments, the same or similar elements will be labeled with the same or similar numerals.

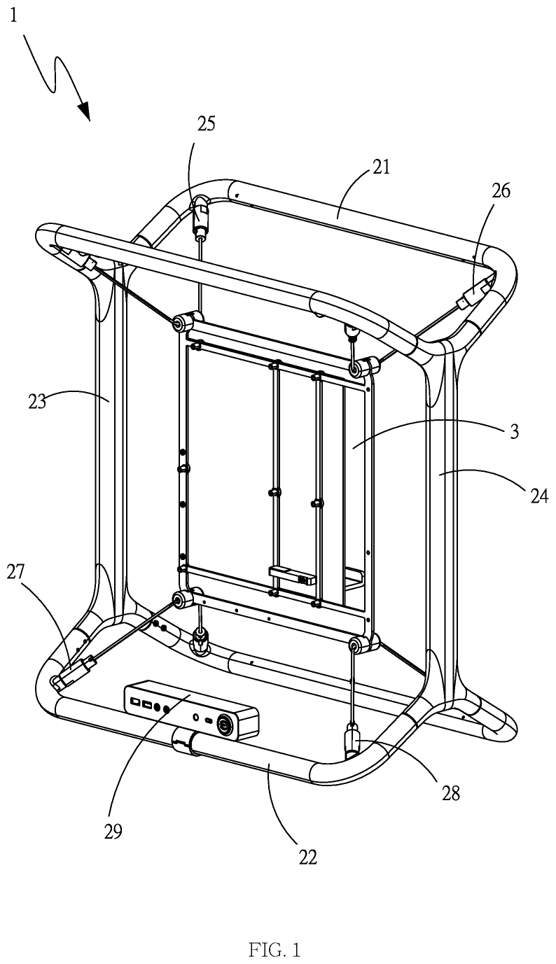

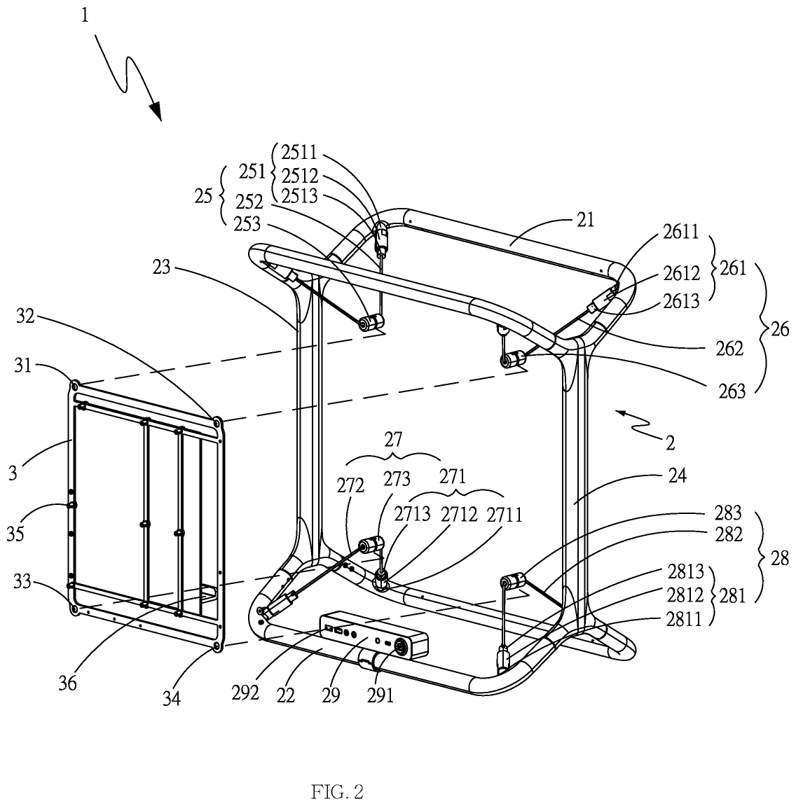

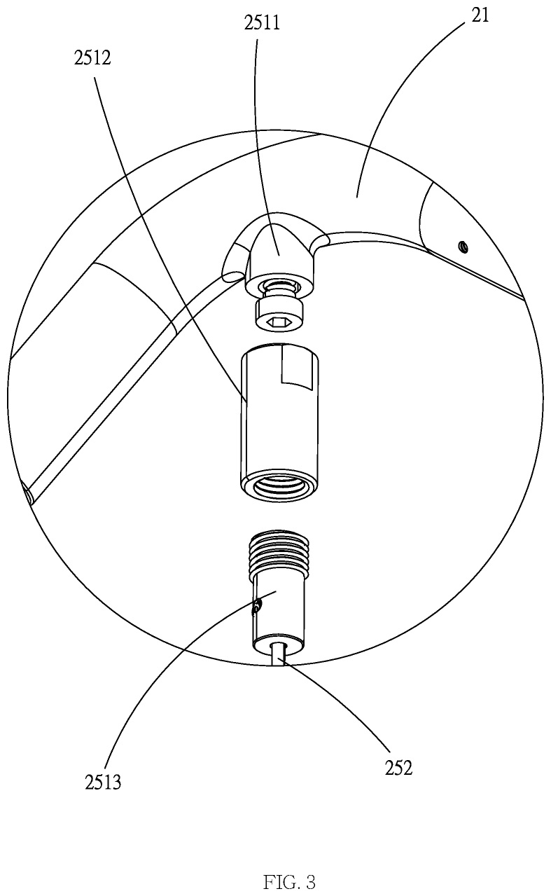

First of all, please refer to FIGS. 1, 2 and 3 for a perspective assembled view; a perspective exploded view; and a partial exploded view of a computer case structure of the invention. It can be clearly seen from the figures that a computer case structure 1 comprises a main frame 2 and a motherboard frame 3.

Wherein the main frame 2 comprises a top frame 21, a bottom frame 22, a front side frame 23 and a rear side frame 24, a top end of the front side frame 23 is assembled with a front side of the top frame 21, a bottom end of the front side frame 23 is assembled with a front side of the bottom frame 22, a top end of the rear side frame 24 is assembled with a rear side of the top frame 21, and a bottom end of the rear side frame 24 is assembled with a rear side of the bottom frame 22, so that the top frame 21 and the bottom frame 22 can be connected to each other through the front side frame 23 and the rear side frame 24 to form the main frame 2.

The motherboard frame 3 is formed with a first assembling hole 31 and a second assembling hole 32, and a third assembling hole 33 and a fourth assembling hole 34, and the motherboard frame 3 is further provided with a plurality of fixing parts 35 and at least one extension part 36, wherein the fixing part 35 can be a locking hole or a sleeve for a motherboard to be assembled on the motherboard frame 3, and the extension part 36 is provided for assembling and fixing at least one motherboard accessory.

The main frame 2 further comprises a first steel cable set 25 and a second steel cable set 26, and a third steel cable set 27 and a fourth steel cable set 28, wherein the first steel cable set 25 is disposed on the front side of the top frame 21, the first steel cable set 25 is provided with two lock heads 251, at least one cable 252, and at least one assembling joint 253, the lock heads 251 of the first steel cable set 25 are respectively assembled on two sides of a front end of the top frame 21, each of the lock heads 251 further comprises a frame assembling section 2511, a rotating section 2512, and a cable assembling section 2513, the frame assembling section 2511 is assembled with the top frame 21, one end of the rotating section 2512 is assembled with the frame assembling section 2511, another end of the rotating section 2512 is assembled with the cable assembling section 2513, the cable assembling section 2513 is assembled with one end of the cable 252, another end of the cable 252 is assembled with the cable assembling section 2513 of the other lock head 251, the cable 252 of the first steel cable set 25 passes through the first assembling hole 31, and the assembling joint 253 of the first steel cable set 25 is sleeved on the cable 252 and fixed on the first assembling hole 31.

Wherein the second steel cable set 26 is disposed on the rear side of the top frame 21, the second steel cable set 26 is provided with two lock heads 261, at least one cable 262, and at least one assembling joint 263, the lock heads 261 of the second steel cable set 26 are respectively assembled on two sides of a rear end of the top frame 21, each of the lock heads 261 further comprises a frame assembling section 2611, a rotating section 2612, and a cable assembling section 2613, the frame assembling section 2611 is assembled with the top frame 21, one end of the rotating section 2612 is assembled with the frame assembling section 2611, another end of the rotating section 2612 is assembled with the cable assembling section 2613, the cable assembling section 2613 is assembled with one end of the cable 262, another end of the cable 262 is assembled with the cable assembling section 2613 of the other lock head 261, the cable 262 of the second steel cable set 26 passes through the second assembling hole 32, and the assembling joint 263 of the second steel cable set 26 is sleeved on the cable 262 and fixed on the second assembling hole 32.

Wherein the third steel cable set 27 is disposed on the front side of the bottom frame 22, the third steel cable set 27 is provided with two lock heads 271, at least one cable 272, and at least one assembling joint 273, the lock heads 271 of the third steel cable set 27 are respectively assembled on two sides of a front end of the bottom frame 22, each of the lock heads 271 further comprises a frame assembling section 2711, a rotating section 2712, and a cable assembling section 2713, the frame assembling section 2711 is assembled with bottom frame 22, one end of the rotating section 2712 is assembled with the frame assembling section 2711, another end of the rotating section 2712 is assembled with the cable assembling section 2713, the cable assembling section 2713 is assembled with one end of the cable 272, another end of the cable 272 is assembled with the cable assembling section 2713 of the other lock head 271, the cable 272 of the third steel cable set 27 passes through the third assembling hole 33, and the assembling joint 273 of the third steel cable set 27 is sleeved on the cable 272 and fixed on the third assembling hole 33.

Wherein the fourth steel cable set 28 is disposed on the rear side of the bottom frame 22, the fourth steel cable set 28 is provided with two lock heads 281, at least one cable 282, and at least one assembling joint 283, the lock heads 281 of the fourth steel cable set 28 are respectively assembled on two sides of a rear end of the bottom frame 22, each of the lock heads 281 further comprises a frame assembling section 2811, a rotating section 2812, and a cable assembling section 2813, the frame assembling section 2811 is assembled with the bottom frame 22, one end of the rotating section 2812 is assembled with the frame assembling section 2811, another end of the rotating section 2812 is assembled with the cable assembling section 2813, the cable assembling section 2813 is assembled with one end of the cable 282, another end of the cable 282 is assembled with the cable assembling section 2813 of the other lock head 281, the cable 282 of the fourth steel cable set 28 passes through the fourth assembling hole 34, and the assembling joint 283 of the fourth steel cable set 28 is sleeved on the cable 282 and fixed on the fourth assembling hole 34.

Wherein the main frame 2 is further provided with a switch assembly 29 electrically connected to the motherboard on the motherboard frame 3, the switch assembly 29 is assembled on the bottom frame 22, and the switch assembly 29 is provided with at least one control switch 291 and at least one connection port 292.

Thereby, the first assembling hole 31 of the motherboard frame 3 is assembled with the first steel cable set 25, the second assembling hole 32 is assembled with the second steel cable set 26, the third assembling hole 33 is assembled with the third steel cable set 27, and the fourth assembling hole 34 is assembled with the fourth steel cable set 28, so that the motherboard frame 3 is capable of suspending and fixing inside the main frame 2. The motherboard on the motherboard frame 3 is capable of achieving effects of shockproof and buffering through the first steel cable set 25, the second steel cable set 26, the third steel cable set 27 and the fourth steel cable set 28. The motherboard frame 3 is suspended and fixed inside the main frame 2 so that air around the motherboard on the motherboard frame 3 is capable of circulating efficiently and providing good diversion effect, thereby achieving an efficacy of effectively improving a heat dissipation effect.

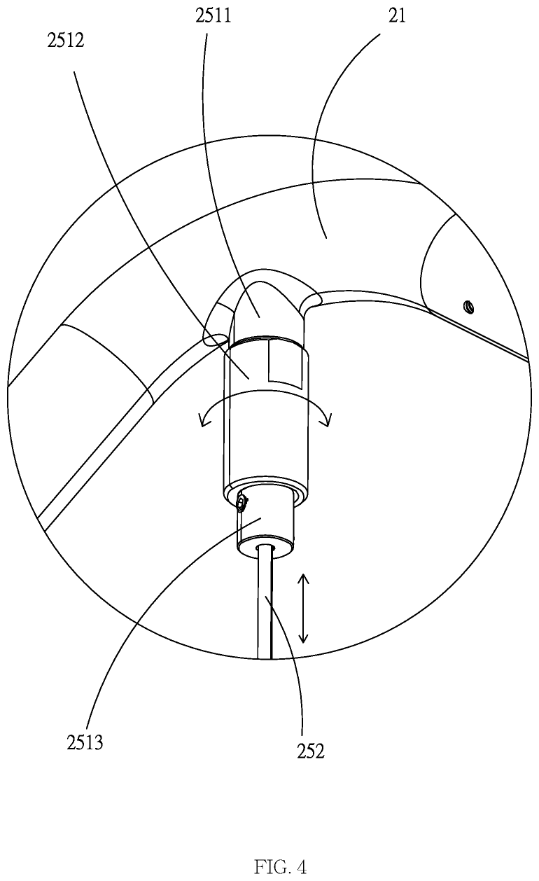

Please refer to the foregoing drawings and FIG. 4 for a partial perspective view of implementation of the computer case structure of the invention. In this embodiment, the lock head 251 of the first steel cable set 25 is used as an implementation mode, wherein one of the ends of the rotating section 2512 is assembled with the frame assembling section 2511, the other end of the rotating section 2512 is assembled with the cable assembling section 2513 with screw threads, and the cable assembling section 2513 is assembled with one of the ends of the cable 252. Therefore, when the rotating section 2512 rotates in a direction toward the top frame 21, the rotating section 2512 is capable of driving the cable assembling section 2513 to displace as the rotating section 2512 is screwed with the cable assembling section 2513. When the rotating section 2512 causes the cable assembling section 2513 to displace in a direction toward the top frame 21, the cable 252 is also pulled by the cable assembling section 2513 and moved in a direction toward the top frame 21 and is tightened. When the cable 252 is tightened, the assembling joint 253 on the cable 252 also moves in a direction toward the top frame 21, thereby driving a suspension position of the motherboard frame 3. On the contrary, when the rotating section 2512 causes the cable assembling section 2513 to displace in a direction toward the motherboard frame 3, the cable 252 is loosened as the cable assembling section 2513 moves in a direction toward the motherboard frame 3. When the cable 252 is loosened, the assembling joint 253 on the cable 252 also moves toward the bottom frame 22, thereby driving a suspension position of the motherboard frame 3. Thereby, the motherboard frame 3 can be controlled by the first steel cable set 25, the second steel cable set 26, the third steel cable set 27 and the fourth steel cable set 28 to adjust its up and down, left and right, front and rear suspension positions inside the main frame 2.

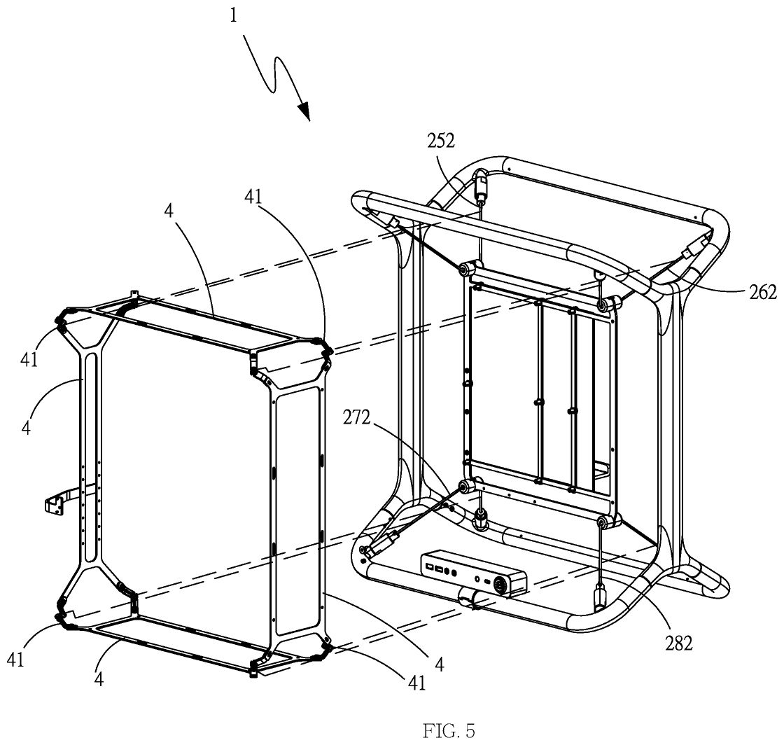

Please refer to the foregoing drawings and FIG. 5 for a perspective view of implementation of the computer case structure assembling with an expansion frame of the invention. Wherein the computer case structure 1 can further comprise at least one expansion frame 4, a side of the expansion frame 4 is provided with a plurality of expansion hooks 41, the expansion hooks 41 can be assembled with the cables 252, 262, 272, 282, and the expansion frame 4 can be assembled horizontally or vertically. In this embodiment, four sets of the expansion frames 4 are used as an implementation mode. Wherein when the expansion frame 4 is disposed horizontally, through the expansion hooks 41 the expansion frame 4 can be respectively hooked on the cable 252 of the first steel cable set 25 and the cable 262 of the second steel cable set 26, so that the expansion frame 4 is positioned inside the main frame 2 and is relatively disposed above the motherboard frame 3. Alternatively, through the expansion hooks 41 the expansion frame 4 can be respectively hooked on the cable 272 of the third steel cable set 27 and the cable 282 of the fourth steel cable set 28, so that the expansion frame 4 is positioned inside the main frame 2 and is relatively disposed below the motherboard frame 3. Alternatively, through the expansion hooks 41 the expansion frame 4 can be respectively hooked on the cable 252 of the first steel cable set 25 and the cable 272 of the third steel cable set 27, so that the expansion frame 4 is positioned inside the main frame 2 and is relatively disposed in front of the motherboard frame 3. Alternatively, through the expansion hooks 41 the expansion frame 4 can be respectively hooked on the cable 262 of the second steel cable set 26 and the cable 282 of the fourth steel cable set 28, so that the expansion frame 4 is positioned inside the main frame 2 and is relatively disposed behind the motherboard frame 3. After the expansion frame 4 is positioned, the expansion frame 4 can be provided for assembling and fixing computer accessories such as heat sink.

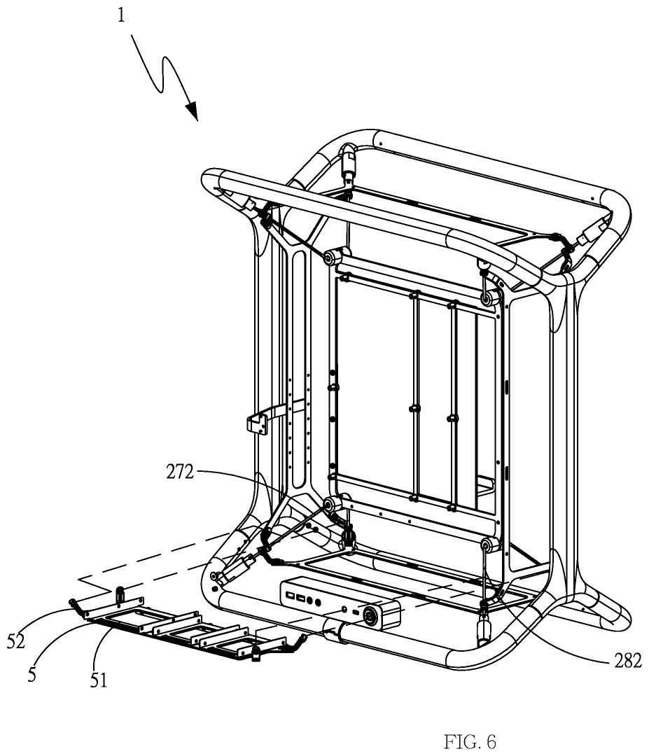

Please refer to the foregoing drawings and FIG. 6 for a perspective view of implementation of the computer case structure assembling with a carrying bracket of the invention. Wherein the computer case structure 1 can further comprise at least one carrying bracket 5, the carrying bracket 5 is provided with at least one partition tray 51 and a plurality of carrying hooks 52 disposed on sides of the carrying bracket 5, and the carrying hooks 52 are assembled with the cables 252, 262, 272, 282. In this embodiment, through the carrying hooks 52 the carrying bracket 5 can be respectively hooked on the cable 272 of the third steel cable set 27 and the cable 282 of the fourth steel cable set 28, so that the carrying bracket 5 is positioned inside the main frame 2 and is relatively disposed below the motherboard frame 3. After the carrying bracket 5 is positioned, the partition tray 51 of the carrying bracket 5 can be provided for assembling and fixing computer accessories such as hard disk drive.

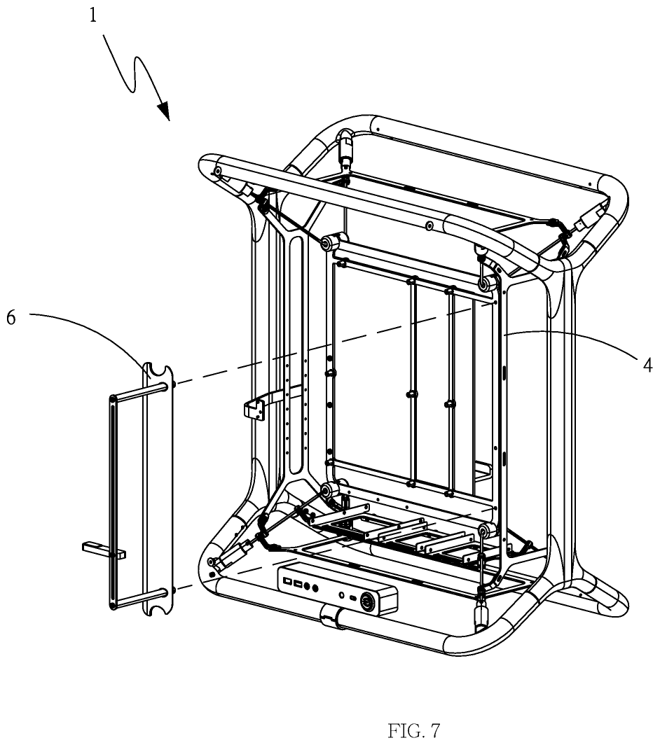

Please refer to the aforementioned drawings and FIG. 7 for a perspective view of implementation of the computer case structure assembling with an expansion rack of the invention. Wherein the computer case structure 1 can further comprise at least one expansion rack 6, wherein the expansion rack 6 can be assembled with the expansion frame 4, and after the expansion rack 6 is positioned, the expansion rack 6 can be provided for assembling and fixing computer accessories.

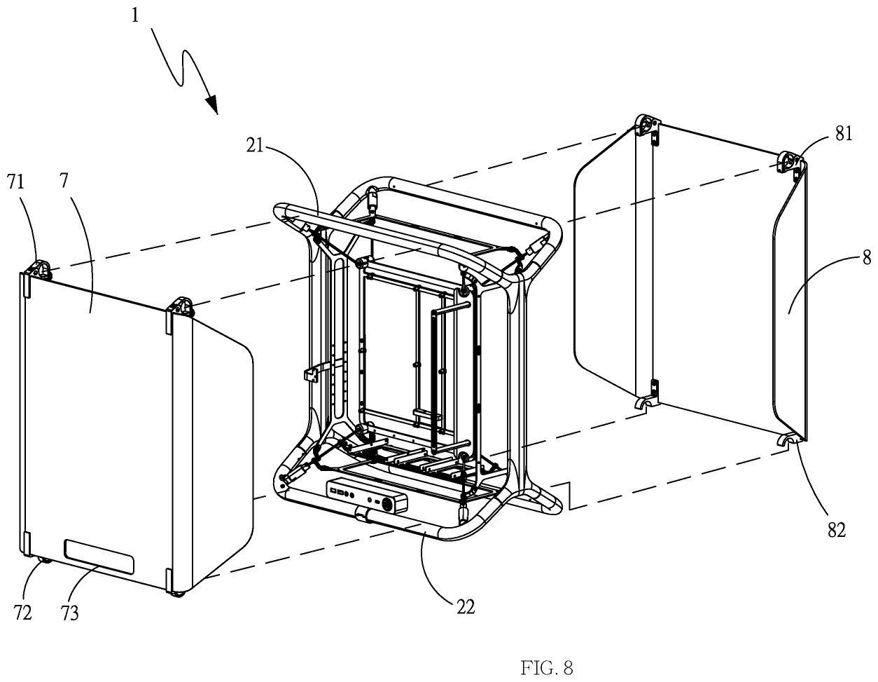

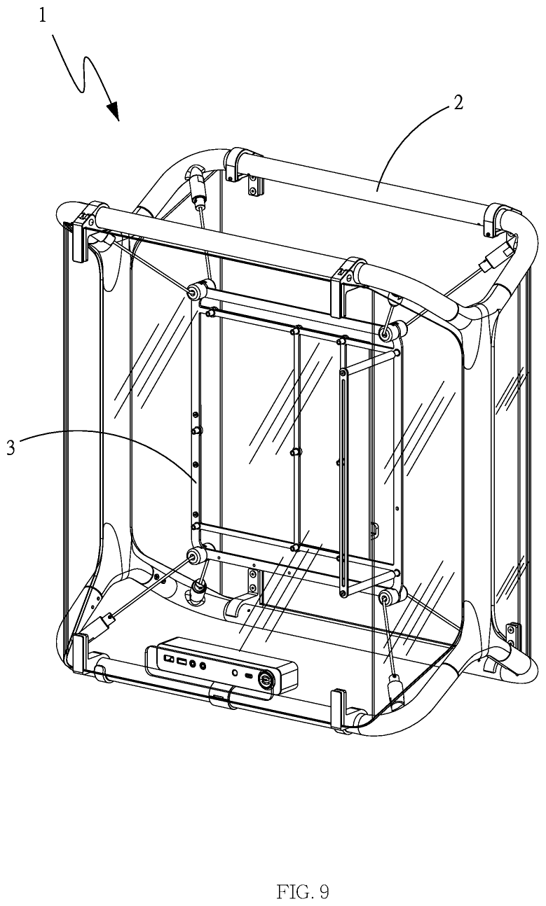

Please refer to the aforementioned drawings and FIGS. 8 and 9 for a perspective view of implementation of the computer case structure assembling with a front cover and a rear cover of the invention; and a perspective view of expansional assembly of the computer case structure of the invention respectively. Wherein the computer case structure 1 can further comprise a front cover 7 and a rear cover 8 formed of transparent material, a top and a bottom of the front cover 7 and the rear cover 8 are respectively provided with at least one top assembling ring 71, 81 and at least one bottom hook 72, 82, wherein after the bottom of the front cover 7 is locked with the bottom hook 72 by a screw element, the bottom hook 72 and the bottom frame 22 can be assembled with each other, and after the top of the front cover 7 is locked with the top assembling ring 71 by a screw element, the top assembling ring 71 can be sleeved on the top frame 21 and locked and fixed, so that the front cover 7 is fixedly disposed on a side of the main frame 2. The front cover 7 is further formed with a through hole 73 communicating with the switch assembly 29 to facilitate operation of the switch assembly 29 through the through hole 73, after the bottom of the rear cover 8 is locked with the bottom hook 82 by a screw element, the bottom hook 82 and the bottom frame 22 can be assembled with each other, and after the top of the rear cover 8 is locked with the top assembling ring 81 by a screw element, the top assembling ring 81 can be sleeved on the top frame 21 and locked and fixed, so that the rear cover 8 is fixedly disposed on another side of the main frame 2, but a way of assembling is not limited thereto. Thereby, the main frame 2 and the motherboard frame 3 can be covered by the front cover 7 and the rear cover 8 to be provided with a protective effect.

It is to be understood that the above description is only preferred embodiments of the invention and is not used to limit the invention, and changes in accordance with the concepts of the invention may be made without departing from the spirit of the invention, for example, the equivalent effects produced by various transformations, variations, modifications and applications made to the configurations or arrangements shall still fall within the scope covered by the appended claims of the invention.

What is claimed is:

1. A computer case structure suspended and fixed by steel cables comprising:
a main frame, the main frame comprising a top frame and a bottom frame connected to each other, and the main frame further comprising a first steel cable set and a second steel cable set, and a third steel cable set and a fourth steel cable set, the first steel cable set being disposed on a front side of the top frame, the second steel cable set being disposed on a rear side of the top frame, the third steel cable set being disposed on a front side of the bottom frame, and the fourth steel cable set being disposed on a rear side of the bottom frame; and
a motherboard frame, the motherboard frame being formed with a first assembling hole and a second assembling hole, and a third assembling hole and a fourth assembling hole, the first assembling hole being assembled with the first steel cable set, the second assembling hole being assembled with the second steel cable set, the third assembling hole being assembled with the third steel cable set, and the fourth assembling hole being assembled with the fourth steel cable set, so that the motherboard frame being capable of suspending and fixing inside the main frame.

2. The computer case structure suspended and fixed by steel cables as claimed in claim 1, wherein the main frame further comprises a front side frame and a rear side frame, a top end of the front side frame is assembled with the front side of the top frame, a bottom end of the front side frame is assembled with the front side of the bottom frame, a top end of the rear side frame is assembled with the rear side of the top frame, a bottom end of the rear side frame is assembled with the rear side of the bottom frame, and the main frame is further provided with a switch assembly, the switch assembly is assembled on the bottom frame, and at least one control switch and at least one connection port are disposed on the switch assembly.

3. The computer case structure suspended and fixed by steel cables as claimed in claim 1, wherein the motherboard frame is further provided with a plurality of fixing parts and at least one extension part thereon, wherein the fixing part is provided for assembling a motherboard on the motherboard frame, and the extension part is provided for assembling and fixing at least one motherboard accessory.

4. The computer case structure suspended and fixed by steel cables as claimed in claim 1, wherein the first steel cable set and the second steel cable set are respectively provided with two lock heads, at least one cable and at least one assembling joint, the lock heads of the first steel cable set are assembled with the top frame, one end of the cable is assembled with one of the lock heads, another end of the cable is assembled with the other lock head, the cable of the first steel cable set passes through the first assembling hole, the assembling joint of the first steel cable set is sleeved on the cable and fixed on the first assembling hole, the lock heads of the second steel cable set are assembled with the top frame, one end of the cable is assembled with one of the lock heads, another end of the cable is assembled with the other lock head, the cable of the second steel cable set passes through the second assembling hole, and the assembling joint of the second steel cable set is sleeved on the cable and fixed on the second assembling hole.

5. The computer case structure suspended and fixed by steel cables as claimed in claim 4, wherein the third steel cable set and the fourth steel cable set are respectively provided with the two lock heads, the at least one cable and the at least one assembling joint, the lock heads of the third steel cable set are assembled with the bottom frame, one end of the cable is assembled with one of the lock heads, another end of the cable is assembled with the other lock head, the cable of the third steel cable set passes through the third assembling hole, the assembling joint of the third steel cable set is sleeved on the cable and fixed on the third assembling hole, the lock heads of the fourth steel cable set are assembled with the bottom frame, one end of the cable is assembled with one of the lock heads, another end of the cable is assembled with the other lock head, the cable of the fourth steel cable set passes through the fourth assembling hole, and the assembling joint of the fourth steel cable set is sleeved on the cable and fixed on the fourth assembling hole.

6. The computer case structure suspended and fixed by steel cables as claimed in claim 5, wherein the lock head further comprises a frame assembling section, a rotating section and a cable assembling section, wherein one end of the rotating section is assembled with the frame assembling section, another end of the rotating section is assembled with the cable assembling section, and the cable assembling section is assembled with the cable, so that the rotating section is capable of driving the cable assembling section to displace to pull or loosen the cable.

7. The computer case structure suspended and fixed by steel cables as claimed in claim 5, further comprising at least one expansion frame, a side of the expansion frame being provided with a plurality of expansion hooks to be assembled with the cable, and the expansion frame being provided for assembling and fixing at least one computer accessory.

8. The computer case structure suspended and fixed by steel cables as claimed in claim 7, further comprising at least one carrying bracket, the carrying bracket being provided with at least one partition tray and a plurality of carrying hooks disposed on sides of the carrying bracket, the carrying hooks being assembled with the cables, and the partition tray being provided for assembling and fixing the computer accessory.

9. The computer case structure suspended and fixed by steel cables as claimed in claim 7, further comprising at least one expansion rack, and the expansion rack being assembled with the expansion frame.

10. The computer case structure suspended and fixed by steel cables as claimed in claim 2, further comprising a front cover and a rear cover, a top and a bottom of the front cover and the rear cover being respectively provided with at least one top assembling ring and at least one bottom hook, the top assembling ring being assembled with the top frame, and the bottom hook being assembled with the bottom frame, so that the front cover and the rear cover being fixedly disposed on sides of the main frame and covering the motherboard frame, and the front cover being further formed with a through hole communicating with the switch assembly.
